(19) United States
(12) Patent Application Publication
(10) Pub. No.: US 2025/0098901 A1
(43) Pub. Date: Mar. 27, 2025

(54) DETACHABLE ELECTRIC STIRRING CUP

(71) Applicant: Suqing Guo, Quanzhou (CN)

(72) Inventor: Kailong Zeng, Wenzhou (CN)

(21) Appl. No.: 18/822,667

(22) Filed: Sep. 3, 2024

(30) Foreign Application Priority Data
Sep. 25, 2023 (CN) 202322610284.3

(51) Int. Cl. A47J 43/046; A47G 19/22; A47J 43/07; A47J 43/08; B01F 33/452; B01F 35/32; B01F 101/14

(52) U.S. Cl. CPC A47J 43/0465; A47G 19/2272; A47J 43/0727; A47J 43/085; B01F 33/452; B01F 35/3211; B01F 35/3213; B01F 2101/14

(57) ABSTRACT

A detachable electric stirring cup is provided, which includes a cup body and a base detachably provided at a bottom of the cup body. The base is provided with a magnetic driver, a driving source for driving the magnetic driver, and a button for controlling the driving source. By placing a magnetic rod inside the cup body and pressing the button to drive the driving source so as to drive the magnetic driver and drive the magnetic rod, thereby stirring is achieved; a connection between the cup body and the base is achieved through rotating clamping. The base is separated from the cup body by magnetic stirring and a detachable base, thereby being suitable for different cups. At the same time, all electrical components are located on the base, the cup body is a container for drinking and placing water. Thus, it is easy to clean and without leakage.

### CROSS-REFERENCE TO RELATED APPLICATIONS

This application claims priority to Chinese Patent Application No. 202322610284.3, filed on Sep. 25, 2023, which is hereby incorporated by reference in its entirety.

### TECHNICAL FIELD

The present disclosure relates to the field of stirring cup technologies, and in particular, to a detachable electric stirring cup.

### BACKGROUND

When people drink instant beverages such as milk powder and coffee, they usually need to manually stir with a spoon to fully stir water and dissolved substance. Due to a slow speed of manual stirring, it is easy to cause insufficient stirring and a precipitation of the dissolved substance. Therefore, an electric stirring cup has emerged, which is equipped with a stirring member at a bottom of the cup. The stirring member is driven to rotate by a motor inside the cup to achieve stirring. However, since the stirring member cannot be disassembled, it can only be used to stir the cup that has been adapted, and cannot be applied to other cups. In additional, due to a non-disassembly of the stirring member, it is not convenient to clean the stirring member and cup body. Furthermore, during cleaning, it may leak into the cup and affect the motor.

### SUMMARY

A purpose of the present disclosure is to provide a detachable electric stirring cup, a base can be separated from a cup body through providing with magnetic stirring and a detachable base, and it can be used for different cups. At the same time, all electrical components are on the base, and the cup body is purely a container for drinking and placing water, rendering it easy to clean and without leakage, thereby solving a problem of existing stirring cups.

The purpose of the present disclosure is achieved as follows.

A detachable electric stirring cup, including a cup body and a base that is detachably provided at a bottom of the cup body; the base is provided with a magnetic driver and a driving source configured to drive the magnetic driver; the base is further provided with a button configured to control the driving source; by placing a magnetic rod inside the cup body and pressing the button, the driving source is driven to drive the magnetic driver and drive the magnetic rod to achieve stirring;
a connection between the cup body and the base is achieved through rotating clamping.

In some embodiments of the present disclosure, the bottom of the cup body is provided with an installation groove, an inner wall of the installation groove is provided with a protrusion; the base is provided with a boss corresponding to the installation groove, an outer side of the boss is provided with a grooved rail, and the protrusion is located inside the grooved rail and moves on the grooved rail;
the grooved rail is provided with a convex strip, the protrusion passes through the convex strip and is located between an inner wall of the grooved rail and the convex strip so as to limit a movement of the protrusion; and/or,
a top of the protrusion is provided with a protruding part, the inner wall of the grooved rail is provided with a clamp slot corresponding to the protruding part; a movement of the protrusion is limited by a cooperation between the protruding part and the clamp slot.

In some embodiments of the present disclosure, the protrusion includes a first protrusion and a second protrusion; both the first protrusion and the second protrusion are located inside the grooved rail, where a top of the second protrusion is provided with the protrusion part, and the first protrusion passes through the convex strip and is located between the inner wall of the grooved rail and the convex strip.

In some embodiments of the present disclosure, the base includes a bottom plate and a shell provided on the bottom plate, and the shell is connected to the bottom of the cup body by rotating clamping;
the magnetic driver and the driving source are provided between the bottom plate and the shell, and the button is provided on the shell; a bottom of the bottom plate is provided with an anti-slip pad; a circuit board electrically connected to the button is provided between the bottom plate and the driving source; the circuit board is provided with a charging connector and connected to a power source; the shell is provided with an opening corresponding to the charging connector; the opening is provided with a dust cover.

In some embodiments of the present disclosure, the cup body includes an outer cup and an inner cup provided in the outer cup, a top of the outer cup is provided with an installation strip, a peripheral side of a top of the inner cup is provided with an installation block, and the installation block is provided with a connection groove corresponding to the installation strip.

In some embodiments of the present disclosure, the cup body is provided with a lid; the lid is provided with a drinking water outlet and provided with a rotatable flip cover;
the flip cover is provided with a sealing part corresponding to the drinking water outlet, and the flip cover is provided with a handheld part for easy use of the flip cover.

In some embodiments of the present disclosure, the flip cover is provided with a connection plate, an inner wall of the connection plate is provided with a first bump; the lid is provided with a recess corresponding to the first bump, and the lid is provided with a second bump on the recess, and the first bump is located in the recess and abuts against the second bump.

The outstanding and beneficial technical effects of the present disclosure compared to existing technologies are as following.

The base is separated from the cup body through providing with magnetic stirring and a detachable base, rendering it suitable for different cups. At the same time, all electrical components are located on the base, and the cup body is purely a container for drinking and placing water, thus it is easy to clean and without leakage.

### BRIEF DESCRIPTION OF DRAWINGS

FIG. 1 is a schematic structural diagram of the present disclosure.

FIG. 2 is a schematic structural diagram in cross-section of the present disclosure.

FIG. 3 is an enlarged schematic structural diagram of A in FIG. 2.

FIG. 4 is a disassembled schematic structural diagram of the present disclosure.

FIG. 5 is a schematic structural diagram of a cup body.

FIG. 6 is a disassembly schematic structural diagram of the cup body.

FIG. 7 is a schematic structural diagram of an inner cup.

FIG. 8 is a disassembly schematic structural diagram of a base.

FIG. 9 is a schematic structural diagram of a shell.

Numeral reference: 1—cup body; 11—installation groove; 12—protrusion; 121—first protrusion; 122—second protrusion; 123—third protrusion; 14—outer cup; 141—installation strip; 15—inner cup; 151—installation block; 152—connection groove; 2—base; 21—boss; 22—grooved rail; 23—convex strip; 24—clamp slot; 25—bottom plate; 251—first installation column 1; 26—shell; 261—opening; 262—dust cover; 263—second installation column; 264—third installation column; 265—annular plate; 3—magnetic driver; 4—driving source; 5—button; 6—anti-slip pad; 7—circuit board; 71—charging connector; 8—lid; 81—drinking water outlet; 82—flip cover; 821—sealing part; 822—handheld part; 823—connection plate; 824—first bump; 825—axis; 83—recess; 84—second bump.

### DESCRIPTION OF EMBODIMENTS

The specific implementation modes of the present disclosure will be further explained in detail with reference to the accompanying drawings.

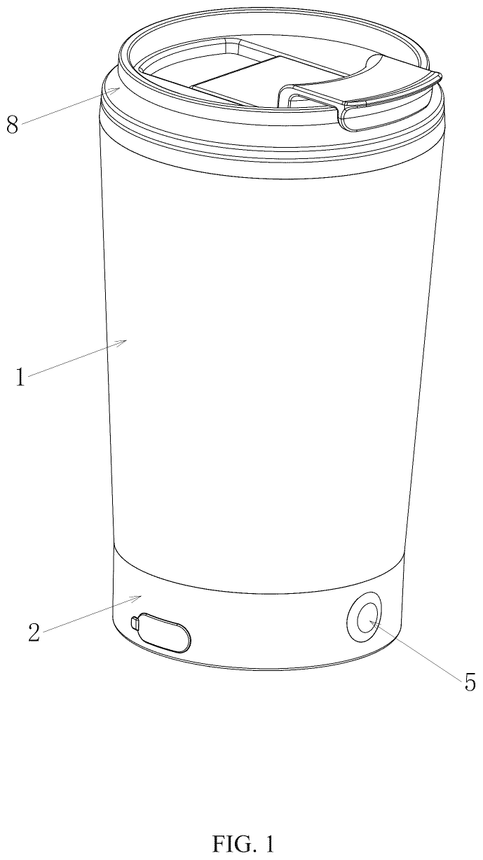

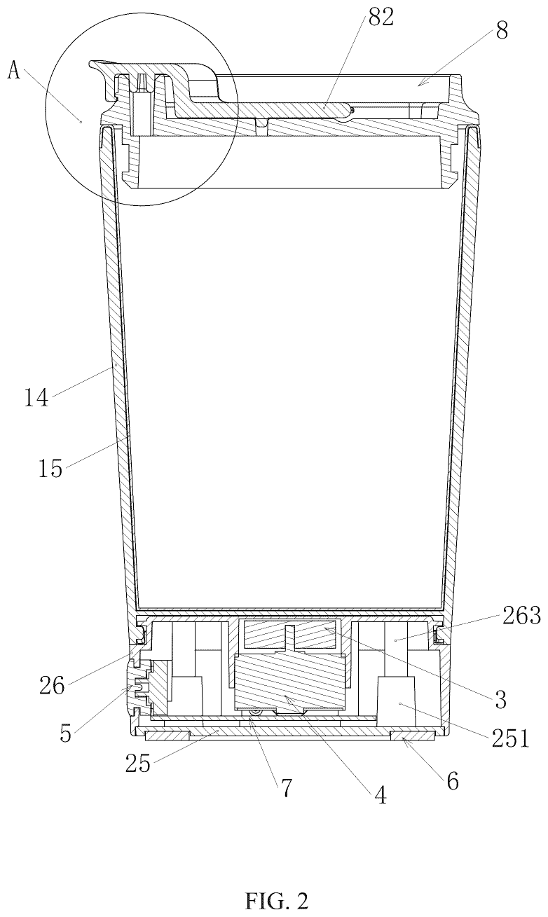

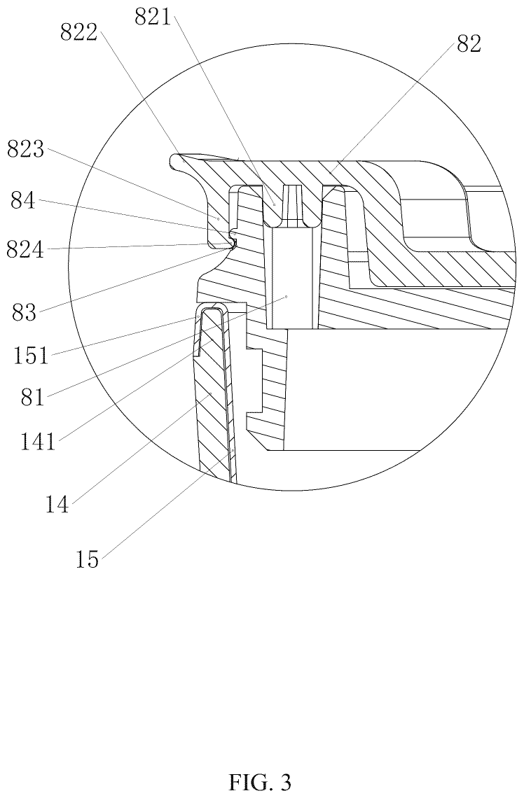

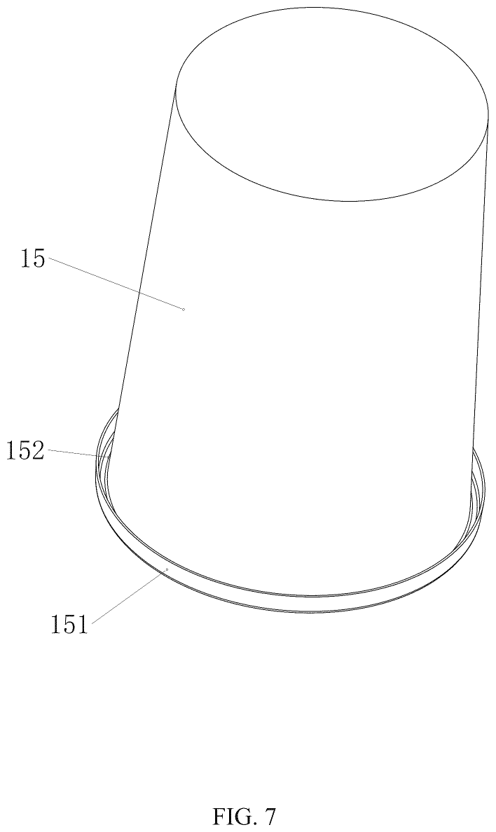

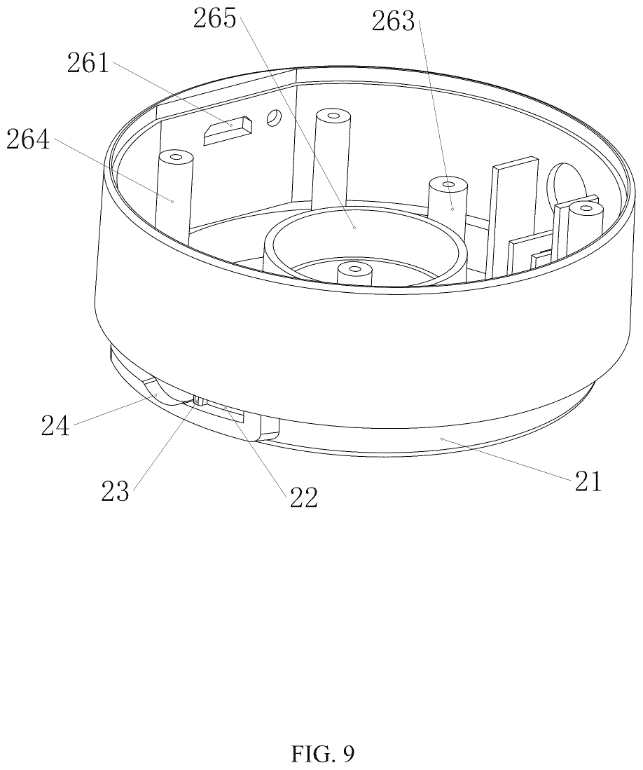

As shown in FIGS. 1-9, a detachable electric stirring cup includes a cup body 1 and a base 2 that can be detachably provided at a bottom of the cup body 1. The base 2 is provided with a magnetic driver 3 and a driving source 4 configured to drive the magnetic driver 3. The base 2 is further provided with a button 5 configured to control the driving source 4. By placing a magnetic rod inside the cup body 1 and pressing the button 5, the driving source 4 is driven to drive the magnetic driver 3 and drive the magnetic rod to achieve stirring.

At the same time, a connection between the cup body 1 and the base 2 is achieved through rotating clamping.

Therefore, in a practical use, by providing magnetic stirring and a detachable base 2, the base 2 can be separated from the cup body 1, rendering it suitable for different cups. At the same time, all electrical components are located on the base 2, and the cup body 1 is purely a container for drinking and placing water. Thus, it is easy to clean and without leakage.

A structure for rotating clamping between the cup body 1 and the base 2 is as follows: firstly, a bottom of the cup body 1 is provided with an installation groove 11, an inner wall of the installation groove 11 is provided with a protrusion 12. The base 2 is provided with a boss 21 corresponding to the installation groove 11, an outer side of the boss 21 is provided with a grooved rail 22; the protrusion 12 is located inside the grooved rail 22 and moves on the grooved rail 22.

Therefore, in an actual use, by rotating the base 2 or the cup body 1, the protrusion 12 is located on and moved on the grooved rail 22, and the clamping is achieved through a limit structure between the protrusion 12 and the grooved rail 22.

There are various limit structures between the protrusion 12 and the grooved rail 22, a convex strip 23 can be provided inside the grooved rail 22; the protrusion 12 passes through the convex strip 23 and is located between an inner wall of the grooved rail 22 and the convex strip 23 so as to limit a movement of the protrusion 12.

In an implementation mode, a protrusion part can be provided at a top of the protrusion 12, and a clamp slot 24 can be provided on an inner wall of the grooved rail 22 corresponding to the protrusion part. By adapting the protrusion part to the clamp slot 24, the movement of the protrusion 12 can be limited.

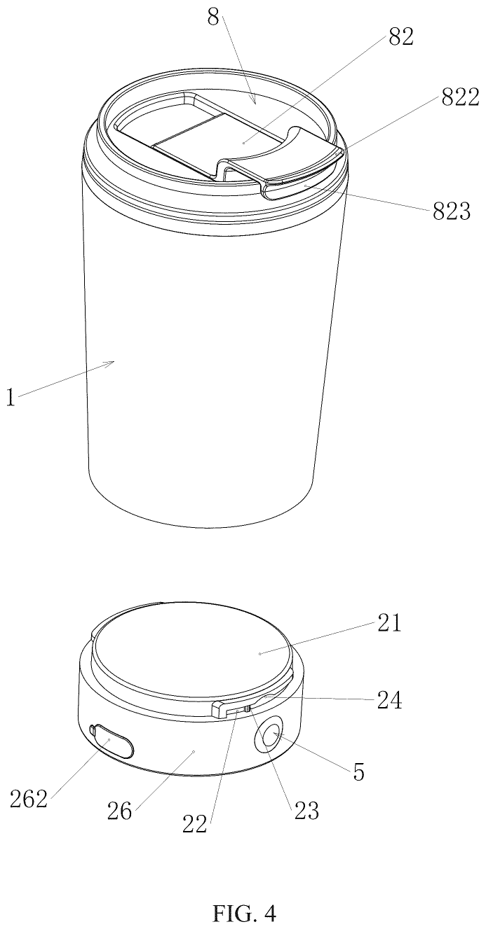

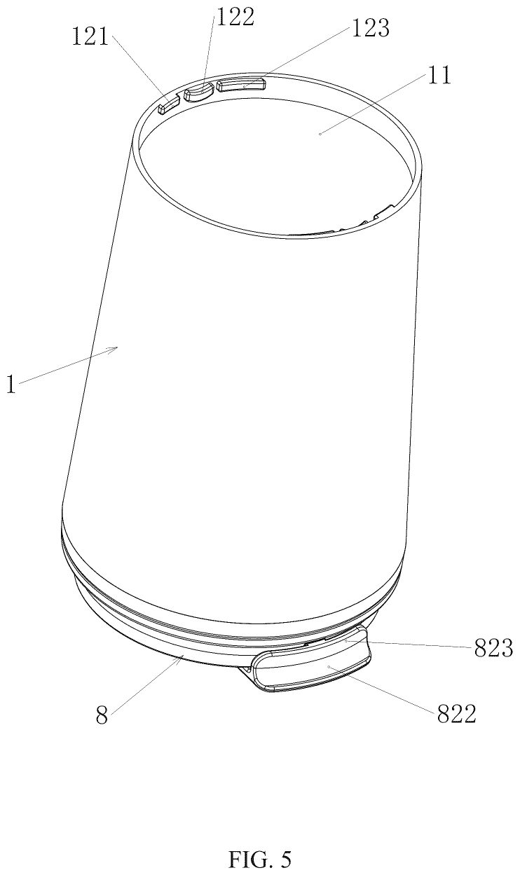

As shown in FIGS. 4 and 5, when two types of limit structures coexist, a specific structure is as follows: firstly, the protrusion 12 includes a first protrusion 121 and a second protrusion 122; both the first protrusion 121 and the second protrusion 122 are located inside the grooved rail 22. A top of the second protrusion 122 is provided with the protrusion part, the first protrusion 121 passes through convex strip 23 and is located between the inner wall of grooved rail 22 and the convex strip 23.

At the same time, the protrusion 12 further includes a third protrusion 123, and the third protrusion 123 is also located inside the grooved rail 22. Although there is no limit to the movement of the protrusion 12, the third protrusion 123 cooperates with grooved rail 22 so as to limit up and down movements.

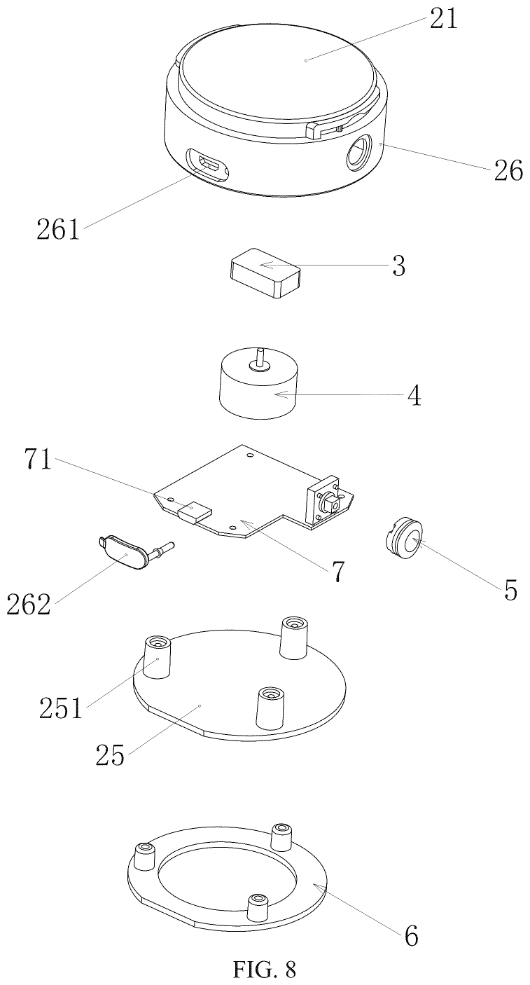

As shown in FIG. 8, a structure of the base 2 is as follows: firstly, the base 2 includes a bottom plate 25 and a shell 26 provided on the bottom plate 25, a connection between the shell 26 and a bottom of the cup body 1 is achieved through rotating clamping.

At the same time, the magnetic driver 3 and the driving source 4 are arranged between the bottom plate 25 and the shell 26, and the button 5 is arranged on the shell 26. An anti-slip pad 6 is provided at a bottom of the bottom plate 25, and a circuit board 7 electrically connected to the button 5 is provided between the bottom plate 25 and the driving source 4. The circuit board 7 is further provided with a charging connector 71 and connected to a power supply. The shell 26 is provided with an opening 261 corresponding to the charging connector 71, and a dust cover 262 is provided inside the opening 261.

Therefore, in an actual use, the power supply is charged through the charging connector 71 to supply power to the driving source 4, the driving source 4 can be a motor, and the dust cover 262 is used to prevent dust and protect the charging connector 71.

The bottom plate 25 and the shell 26 are connected by a fastener, and the fastener can be a screw. A specific structure is as follows: firstly, a hollow first installation column 251 is provided on an inner wall of the bottom plate 25, and a hollow second installation column 263 is provided on an inner wall of the shell 26. One end of the fastener passes through the first installation column 251 and is located inside the second installation column 263, thus achieving the connection.

At the same time, the anti-slip pad 6 is provided with a blocking part corresponding to the first installation column 251 so as to protect and shield the screw. Moreover, the shell 26 is provided with a third installation column 264 and an annular plate 265. The third installation column 264 can be used to install the circuit board 7, while the annular plate 265 can be used to install and limit the magnetic driver 3 and the driving source 4.

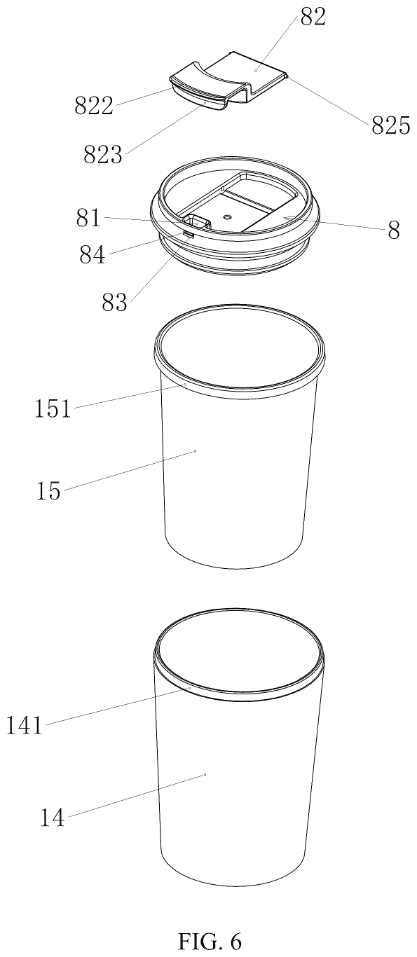

As shown in FIG. 6, a structure of the cup body 1 is as follows: firstly, the cup body 1 includes an outer cup 14 and an inner cup 15 arranged on the outer cup 14. A connection structure between the outer cup 14 and the inner cup 15 is as follows: firstly, a top of the outer cup 14 is provided with an installation strip 141, a peripheral side of a top of the inner cup 15 is provided with an installation block 151, and the installation block 151 is provided with a connection groove 152 corresponding to the installation strip 141. A connection between the outer cup 14 and the inner cup 15 is achieved by a cooperation between the installation strip 141 and the connection groove 152.

As shown in FIGS. 1-9, the cup body 1 is provided with a lid 8, the lid 8 is provided with a drinking water outlet 81 and a rotatable flip cover 82. The flip cover 82 is provided with a sealing part 821 corresponding to the drinking water outlet 81 so as to prevent water leakage. Besides, the flip cover 82 is provided with a handheld part 822 for easy use of the flip cover 82.

A structure between the flip cover 82 and the lid 8 is as follows: firstly, the flip cover 82 is provided with a connection plate 823, an inner wall of the connection plate 823 is provided with a first bump 824, the lid 8 is provided with a recess 83 corresponding to the first bump 824, and the lid 8 is provided with a second bump 84 on the recess 83.

Therefore, in a practical use, a rotation of the flip cover 82 is limited by the first bump 824 being located in the recess 83 and abutting against the second bump 84.

A rotating structure of the flip cover 82 is as follows: firstly, there is an axis 825 on both sides of the flip cover 82, and the lid 8 is provided with a hole corresponding to axis 825, a cooperation between the axis and hole can achieve the rotation.

The above illustrates and describes the basic principles, main features, and advantages of the present disclosure. Meanwhile, the present disclosure is not limited by the above embodiments, and therefore, without departing from the principles and scope of the present disclosure, there will be various changes and improvements to the present disclosure, all of which fall within the scope of the present disclosure.

What is claimed is:

1. A detachable electric stirring cup, comprising a cup body (1) and a base (2) detachably disposed at a bottom of the cup body (1); wherein the base (2) is internally provided with a magnetic driver (3) and a driving source (4) configured to drive the magnetic driver (3), the base (2) is provided with a button (5) configured to control the driving source (4), and by placing a magnetic rod in the cup body (1) and pressing the button (5), the driving source (4) is driven to drive the magnetic driver (3) and drive the magnetic rod to implement stirring; and
the cup body (1) is connected to the base (2) through rotating clamping.

2. The detachable electric stirring cup according to claim 1, wherein the bottom of the cup body (1) is provided with a mounting groove (11), an inner wall of the mounting groove (11) is provided with a protrusion (12), the base (2) is provided with a boss (21) corresponding to the mounting groove (11), an outer side of the boss (21) is provided with a grooved rail (22), and the protrusion (12) is located in the grooved rail (22) and moves on the grooved rail (22);
the grooved rail (22) is internally provided with a convex strip (23), and the protrusion (12) passes through the convex strip (23) and is located between an inner wall of the grooved rail (22) and the convex strip (23) to limit a movement of the protrusion (12); or/and
a top of the protrusion (12) is provided with a protruding part, the inner wall of the grooved rail (22) is provided with a clamping slot (24) corresponding to the protruding part, and the protruding part is adapted to the clamping slot (24) to limit a movement of the protrusion (12).

3. The detachable electric stirring cup according to claim 2, wherein the protrusion (12) comprises a first protrusion (121) and a second protrusion (122), both the first protrusion (121) and the second protrusion (122) are located in the grooved rail (22), a top of the second protrusion (122) is provided with the protrusion part, and the first protrusion (121) passes through the convex strip (23) and is located between the inner wall of the grooved rail (22) and the convex strip (23).

4. The detachable electric stirring cup according to claim 1, wherein the base (2) comprises a bottom plate (25) and a housing (26) disposed on the bottom plate (25), and the housing (26) is connected to the bottom of the cup body (1) through rotating clamping; and
the magnetic driver (3) and the driving source (4) are disposed between the bottom plate (25) and the housing (26), the button (5) is disposed on the housing (26), a bottom of the bottom plate (25) is provided with an anti-slip pad (6), a circuit board (7) electrically connected to the button (5) is disposed between the bottom plate (25) and the driving source (4), the circuit board (7) is provided with a charging connector (71) and connected to a power source, the housing (26) is provided with an opening (261) corresponding to the charging connector (71), and the opening (261) is internally provided with a dustproof cover (262).

5. The detachable electric stirring cup according to claim 1, wherein the cup body (1) comprises an outer cup (14) and an inner cup (15) disposed in the outer cup (14), a top of the outer cup (14) is provided with a mounting strip (141), a peripheral side of a top of the inner cup (15) is provided with a mounting block (151), and the mounting block (151) is provided with a connection groove (152) corresponding to the mounting strip (141).

6. The detachable electric stirring cup according to claim 1, wherein the cup body (1) is provided with a lid (8), the lid (8) is provided with a drinking water outlet (81), the lid (8) is provided with a rotatable flip cover (82), the flip cover (82) is provided with a sealing part (821) corresponding to the drinking water outlet (81), and the flip cover (82) is provided with a handheld part (822) for easy use of the flip cover (82).

7. The detachable electric stirring cup according to claim 6, wherein the flip cover (82) is provided with a connection plate (823), an inner wall of the connection plate (823) is provided with a first bump (824), the lid (8) is provided with a recess (83) corresponding to the first bump (824), the lid (8) is provided with a second bump (84) above the recess (83), and the first bump (824) is located in the recess (83) and abuts against the second bump (84).
